(19) United States
(12) Patent Application Publication
(10) Pub. No.: US 2026/0188911 A1
(43) Pub. Date: Jul. 2, 2026

(54) LOW-RADAR CROSS SECTION (RCS) METASURFACE-BASED ARRAY ANTENNA

(71) Applicant: ANHUI UNIVERSITY, Hefei, Anhui (CN)

(72) Inventors: Lixia YANG, Hefei (CN); Chengwei YU, Hefei (CN); Aidi REN, Hefei (CN)

(73) Assignee: ANHUI UNIVERSITY, Hefei, Anhui (CN)

(21) Appl. No.: 18/839,783

(22) PCT Filed: Apr. 3, 2024
(86) PCT No.: PCT/CN2024/085709

§ 371 Date: Aug. 20, 2024

(30) Foreign Application Priority Data
Jul. 10, 2023 (CN) 202310835827.3

(51) Int. Cl. H01Q 15/00; H01Q 1/48; H01Q 1/50; H01Q 21/00; H01Q 21/06

(52) U.S. Cl. CPC H01Q 15/0086; H01Q 1/48; H01Q 1/50; H01Q 21/0006; H01Q 21/061

(57) ABSTRACT

Provided is a low-radar cross section (RCS) metasurface-based array antenna. The array antenna includes a dielectric substrate, and a transmission line, a plurality of first periodic metal cells and a plurality of second periodic metal cells printed on an upper surface of the dielectric substrate, a metallic ground and a plurality of subminiature version A (SMA) feeding structures printed on a lower surface of the dielectric substrate, the first periodic metal cells and the second periodic metal cells form a metasurface module on the upper surface of the dielectric substrate; an upper end of the SMA feeding structure extends to the upper surface of the dielectric substrate and is connected to the transmission line; the first periodic metal cell is provided with a metal post; the metal post includes a lower end located on the metallic ground, and an upper end extending to the upper surface of the dielectric substrate.

### CROSS REFERENCE TO RELATED APPLICATION

This patent application is a national stage application of International Patent Application No. PCT/CN2024/085709, filed on Apr. 3, 2024, which claims the benefit and priority of Chinese Patent Application No. 2023108358273, filed with the China National Intellectual Property Administration on Jul. 10, 2023, the disclosure of which is incorporated by reference herein in its entirety as part of the present application.

### TECHNICAL FIELD

The present disclosure relates to the technical field of array antennas, and in particular to a low-radar cross section (RCS) metasurface-based array antenna.

### BACKGROUND

In recent years, with rapid development of electronic warfare and information warfare, environments in high-tech electronic warfare are gradually complicated, radar detection techniques are gradually enhanced, and stealth techniques are increasingly concerned. A radar cross section (RCS) is used as an important indicator to determine stealth performance of objects. The lower the RCS, the more likely the objects keep stealth on enemy radars. Array antennas feature the merits of high gain and flexible beams and are widely used in various communication systems. However, due to the particular function of radiating or receiving electromagnetic (EM) waves, they also have been the major RCS contributors to stealthy platforms, such as stealth aircrafts and missiles. It is desirable to design low-RCS array antennas so as to improve the stealthy performance of the whole platform. To this end, researchers have put forward some interesting methods to reduce the RCS of existing array antennas. Despite the RCS reduction achieved in or out of the antenna's working band in most work, another concern is the radiation performance worsening that follows, since a tradeoff is always made between low RCS and well-behaved radiation performance.

Recent years have witnessed fast and significant progresses in metasurfaces. As artificially constructed EM surfaces, the metasurfaces provide an unprecedented way to control EM waves in terms of wavefront, polarization, or even propagation mode. With these features, the RCS of the antennas can be effectively reduced according to energy absorption or re-scattering. Although lots of pioneering work has successfully demonstrated encouraging RCS reduction of array antennas, these designs are mostly based on the application of metasurfaces to existing array antennas, i.e., from the antenna to low-RCS antenna or radiation performance preceding scattering performance. The route from radiation to comprehensive consideration of radiation and low scattering is normally carried out by loading the metasurface to the existing antennas, which is direct and effective. Along with the visible merits, some challenges also exist. First, to some extent, the scattering field control is much more complicated than radiation, thus, it is difficult to balance low RCS and good radiation performance at the same time, which usually results in experience-relying trial-and-error and time-consuming optimization. Second, as a result of the metasurface-application strategy, the total size of the low-RCS array antennas is sometimes artificially enlarged. Moreover, the in-band RCS reduction is still quite challenging without sacrificing the radiation performance.

### SUMMARY

An objective of the present disclosure is to provide a low-RCS metasurface-based array antenna, to solve the above-mentioned problems in the prior art, and realize good radiation performance and a broadband low RCS.

To achieve the above objective, the present disclosure provides the following technical solutions.

The present disclosure provides a low-RCS metasurface-based array antenna, including a dielectric substrate, and a transmission line, a plurality of first periodic metal cells and a plurality of second periodic metal cells printed on an upper surface of the dielectric substrate, and a metallic ground and a plurality of subminiature version A (SMA) feeding structures printed on a lower surface of the dielectric substrate, where the first periodic metal cells and the second periodic metal cells form a metasurface module on the upper surface of the dielectric substrate; an upper end of the SMA feeding structure extends to the upper surface of the dielectric substrate and is connected to the transmission line; a middle of the first periodic metal cell is provided with a metal post; and the metal post includes a lower end located on the metallic ground, and an upper end extending to the upper surface of the dielectric substrate.

Preferably, the metasurface module includes sixteen first periodic metal cells and sixteen second periodic metal cells; the first periodic metal cells are arranged in two C shapes and form two side-by-side C-shaped structures; the second periodic metal cells are arranged in two T shapes and form two side-by-side T-shaped structures; one end of the T-shaped structure forms an extension portion; a groove is formed at one side of the C-shaped structure; the extension portion extends to the groove, so as to make the metasurface module form a 2*1 array antenna; there are two transmission lines; and the transmission lines are respectively located in middles of the extension portions.

Preferably, the metasurface module includes thirty-two first periodic metal cells and thirty-two second periodic metal cells; the first periodic metal cells are arranged in four C shapes and form four C-shaped structures; the four C-shaped structures have a same orientation, and are respectively located at corners of a rectangle; the second periodic metal cells are arranged in four T shapes and form four T-shaped structures; the four T-shaped structures have a same orientation, and are respectively located at corners of a rectangle; one end of the T-shaped structure forms an extension portion; a groove is formed at one side of the C-shaped structure; the extension portion extends to the groove, so as to make the metasurface module form a 2*2 array antenna; there are four transmission lines; and the transmission lines are respectively located in middles of the extension portions.

Preferably, both the metallic ground and the dielectric substrate are rectangular; and outer edges of the metallic ground are respectively flush with outer edges of the dielectric substrate.

Compared with the prior art, the present disclosure has the following technical effects:

According to the low-RCS metasurface-based array antenna provided by the present disclosure, since the first periodic metal cells and the second periodic metal cells form the metasurface module on the upper surface of the dielectric substrate, the low-RCS array antenna can be realized directly from the metasurface. According to the present disclosure, a low-RCS metasurface is designed. The first periodic metal cells and the second periodic metal cells on the metasurface and proper feeding techniques are exploited to excite parts of the metasurface cells to produce efficient radiations. These partially excited cells play twofold roles as radiating structures for the array antenna and as part of scattering structures for the low-RCS property. The upper end of the SMA feeding structure extends to the upper surface of the dielectric substrate and is connected to the transmission line. The metal post is provided in a middle of the first periodic metal cell. The metal post includes the lower end located on the metallic ground, and the upper end extending to the upper surface of the dielectric substrate, thereby connecting the first periodic metal cell to the ground. The present disclosure can obtain a lower RCS and a wider low-RCS band.

### BRIEF DESCRIPTION OF THE DRAWINGS

To describe the technical solutions in embodiments of the present disclosure or in the prior art more clearly, the accompanying drawings required for the embodiments are briefly described below. Apparently, the accompanying drawings in the following description show merely some embodiments of the present disclosure, and those of ordinary skill in the art may still derive other accompanying drawings from these accompanying drawings without creative efforts.

FIG. 1 is a schematic structural view of a first periodic metal cell according to the present disclosure;

FIG. 2 is a schematic structural view of a second periodic metal cell according to the present disclosure;

FIG. 3 is a schematic structural view of an original 2*1 microstrip array antenna working at 14.8 GHz;

FIG. 4 is a schematic structural view of an original 2*2 microstrip array antenna working at 14.8 GHz;

FIG. 5 is a schematic structural view of a low-RCS metasurface-based 2*1 array antenna (without a metal post);

FIG. 6 is a schematic structural view of a low-RCS metasurface-based 2*2 array antenna (without a metal post);

FIG. 7 is a schematic structural view of an improved low-RCS metasurface-based 2*2 array antenna (with a metal post);

FIG. 8 illustrates a simulated S parameter curve of a low-RCS metasurface-based front-rear 2*1 array antenna according to Embodiment 1;

FIG. 9 illustrates a simulated gain curve of a low-RCS metasurface-based front-rear 2*1 array antenna according to Embodiment 1;

FIG. 10 illustrates a simulated S parameter curve of a low-RCS metasurface-based front-rear 2*2 array antenna according to Embodiment 1;

FIG. 11 illustrates a simulated gain curve of a low-RCS metasurface-based front-rear 2*2 array antenna according to Embodiment 1;

FIG. 12 illustrates a simulated S parameter curve of a low-RCS metasurface-based front-rear improved 2*2 array antenna according to Embodiment 1;

FIG. 13 illustrates a simulated gain curve of a low-RCS metasurface-based front-rear improved 2*2 array antenna according to Embodiment 1;

FIG. 14 illustrates a monostatic RCS of a low-RCS metasurface-based front-rear 2*1 array antenna under normal incidence of an x-polarized incident wave according to Embodiment 1;

FIG. 15 illustrates a monostatic RCS of a low-RCS metasurface-based front-rear 2*1 array antenna under normal incidence of a y-polarized incident wave according to Embodiment 1;

FIG. 16 illustrates a monostatic RCS of a low-RCS metasurface-based front-rear 2*2 array antenna under normal incidence of an x-polarized incident wave according to Embodiment 1;

FIG. 17 illustrates a monostatic RCS of a low-RCS metasurface-based front-rear 2*2 array antenna under normal incidence of a y-polarized incident wave according to Embodiment 1;

FIG. 18 illustrates a monostatic RCS of a low-RCS metasurface-based front-rear improved 2*2 array antenna under normal incidence of an x-polarized incident wave according to Embodiment 1; and

FIG. 19 illustrates a monostatic RCS of a low-RCS metasurface-based front-rear improved 2*2 array antenna under normal incidence of a y-polarized incident wave according to Embodiment 1.

In the figures: 1—dielectric substrate, 2—transmission line, 3—first periodic metal cell, 4—second periodic metal cell, 5—metallic ground, 6—SMA feeding structure, and 7—metal post.

### DETAILED DESCRIPTION OF THE EMBODIMENTS

The technical solutions in the embodiments of the present disclosure are clearly and completely described below with reference to the drawings in the embodiments of the present disclosure. Apparently, the described embodiments are merely a part rather than all of the embodiments of the present disclosure. All other embodiments obtained by those skilled in the art based on the embodiments of the present disclosure without creative efforts shall fall within the protection scope of the present disclosure.

An objective of the present disclosure is to provide a low-RCS metasurface-based array antenna, to solve the technical problem that a low RCS and good radiation performance are achieved hardly at the same time in the prior art.

In order to make the above objective, features and advantages of the present disclosure clearer and more comprehensible, the present disclosure will be further described in detail below in combination with accompanying drawings and particular implementation modes.

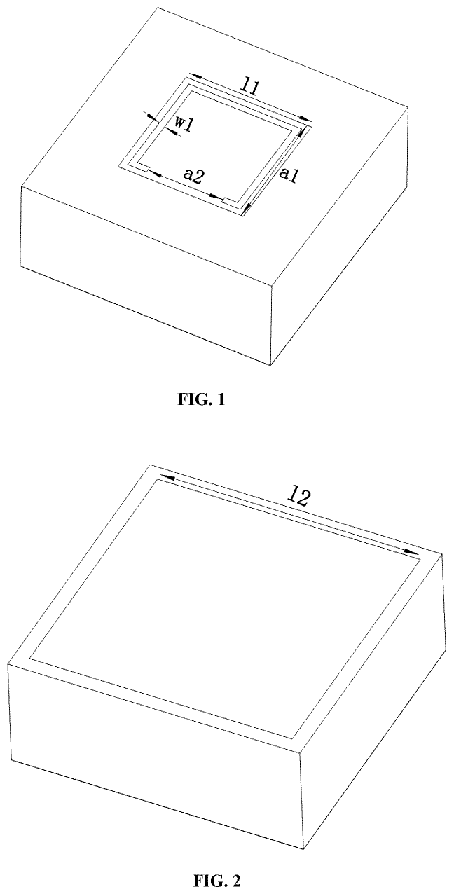

As shown in FIG. 1 to FIG. 7, the embodiment provides a low-RCS metasurface-based array antenna, including a dielectric substrate 1, a transmission line 2, a plurality of first periodic metal cells 3 and a plurality of second periodic metal cells 4 printed on an upper surface of the dielectric substrate 1, and a metallic ground 5 and a plurality of SMA feeding structures 6 printed on a lower surface of the dielectric substrate 1. The first periodic metal cells 3 and the second periodic metal cells 4 form a metasurface module on the upper surface of the dielectric substrate 1. An upper end of the SMA feeding structure 6 extends to the upper surface of the dielectric substrate 1 and is connected to the transmission line 2. In order to achieve a lower RCS and a wider low-RCS band of the low-RCS metasurface-based array antenna, without sacrificing radiation performance, a middle of the first periodic metal cell 3 is provided with a metal post 7. The metal post 7 includes a lower end located on the metallic ground 5, and an upper end extending to the upper surface of the dielectric substrate 1. A 2*1 array antenna and a 2*2 array antenna are meticulously designed, and achieve the good radiation performance and the wider low-RCS band. Both the metallic ground 5 and the dielectric substrate 1 are rectangular. Outer edges of the metallic ground 5 are respectively flush with outer edges of the dielectric substrate 1.

As shown in FIG. 1 to FIG. 2, the first periodic metal cell 3 is a square metal sheet. A U-shaped groove is etched on an upper surface of the first periodic metal cell. Edges of the U-shaped groove are respectively close to outer edges of the first periodic metal cell 3. The second periodic metal cell 4 is a square metal sheet, with the following parameters: 11=2 mm, 12=3.6 mm, a1=1.8 mm, a2=1.2 mm, and w1=0.2 mm.

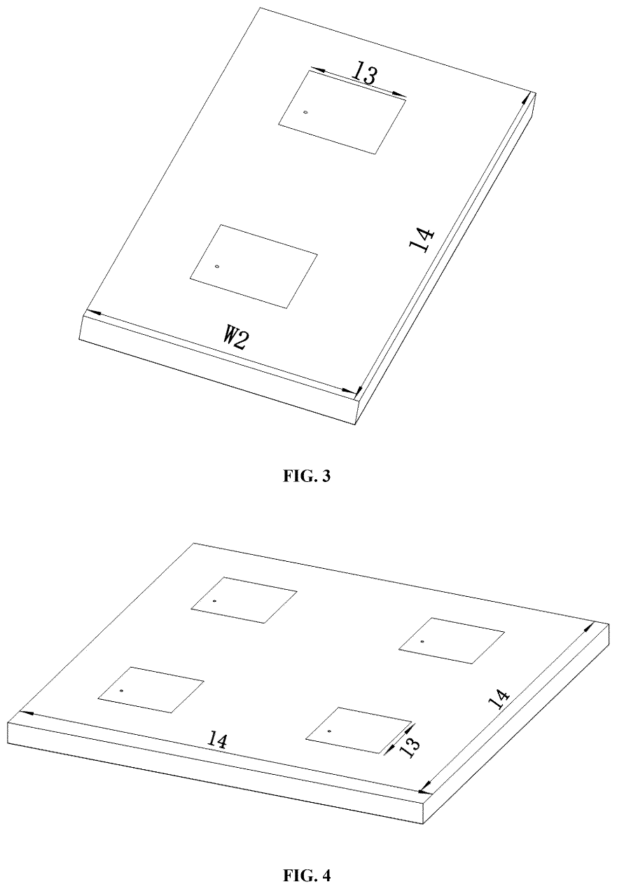

FIG. 3 and FIG. 4 respectively illustrate an original 2*1 microstrip array antenna and an original 2*2 microstrip array antenna working at 14.8 GHz. With a coaxial feeding manner, the antenna includes an original dielectric substrate 1, an original radiation patch, an original metallic ground 5 and an original SMA feeding structure 6. The original SMA feeding structure 6 passes through the original dielectric substrate 1 and the original metallic ground 5. The specific parameters are as follows: l3=5.6 mm, l4=32 mm, and w2=16 mm. The dielectric substrate used by the antenna has a dielectric constant of 2.65 and a loss tangent of 0.003. The whole dielectric substrate of the antenna has a thickness of 1.6 mm.

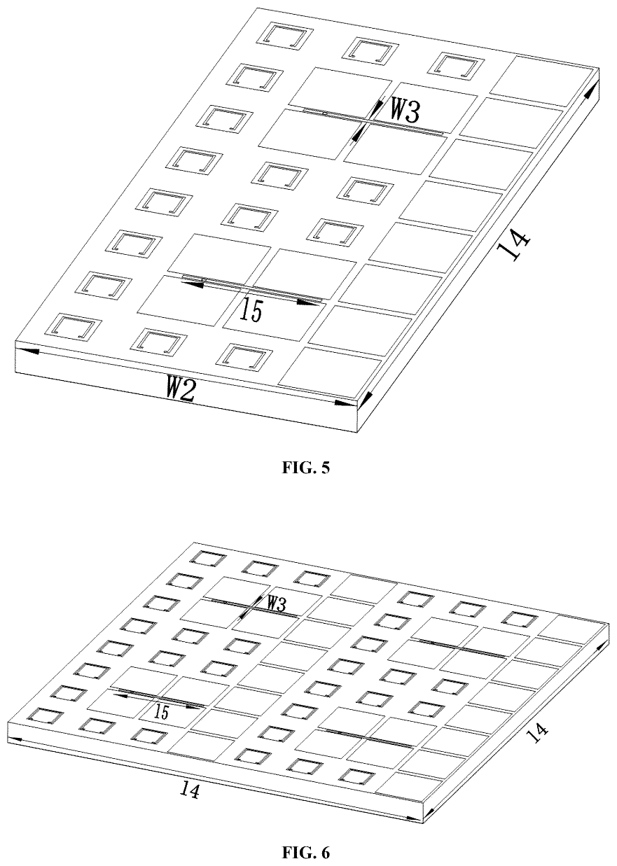

As shown in FIG. 5, the metasurface module includes sixteen first periodic metal cells 3 and sixteen second periodic metal cells 4. The first periodic metal cells 3 are arranged in two C shapes and form two side-by-side C-shaped structures. The second periodic metal cells 4 are arranged in two T shapes and form two side-by-side T-shaped structures. One end of the T-shaped structure forms an extension portion. A groove is formed at one side of the C-shaped structure. The extension portion extends to the groove. That is, the first periodic metal cell 3 and the second periodic metal cell 4 are combined in an interdigital manner, thus making the metasurface module form a 2*1 array antenna.

Under normal incidence of an x-polarized incident wave and a y-polarized incident wave on the metasurface module, effective phase differences within 180°±37° can be obtained to achieve the low RCS. There are two transmission lines 2. The transmission lines are respectively located in middles of the extension portions. The SMA feeding structure 6 passes through the dielectric substrate 1 and the metallic ground 5. The interdigital arrangement of the two periodic metal cells and proper feeding techniques are exploited to excite parts of the metasurface module to produce efficient radiations. These partially excited cells play twofold roles as radiating structures for the array antenna and as part of scattering structures for the low-RCS property. The specific parameters are as follows: l5=6.5 mm, and w3=0.2 mm. The dielectric substrate used by the antenna has a dielectric constant of 2.65 and a loss tangent of 0.003. The whole dielectric substrate of the antenna has a thickness of 1.6 mm.

As shown in FIG. 6, the metasurface module includes thirty-two first periodic metal cells 3 and thirty-two second periodic metal cells 4. The first periodic metal cells 3 are arranged in four C shapes and form four C-shaped structures. The four C-shaped structures have a same orientation, and are respectively located at corners of a rectangle. The second periodic metal cells 4 are arranged in four T shapes and form four T-shaped structures. The four T-shaped structures have a same orientation, and are respectively located at corners of a rectangle. One end of the T-shaped structure forms an extension portion. A groove is formed at one side of the C-shaped structure. The extension portion extends to the groove. The first periodic metal cell 3 and the second periodic metal cell 4 are combined in an interdigital manner, thus making the metasurface module form a 2*2 array antenna. That is, the 2*2 array antenna is composed of two 2*1 side-by-side array antennas. There are four transmission lines 2. The transmission lines are respectively located in middles of the extension portions. Under normal incidence of an x-polarized incident wave and a y-polarized incident wave on the metasurface, effective phase differences within 180°±37° can be obtained to achieve the low RCS. The SMA feeding structure 6 passes through the dielectric substrate 1 and the metallic ground 5. The interdigital arrangement of the two periodic metal cells and proper feeding techniques are exploited to excite parts of the metasurface cells to produce efficient radiations. These partially excited cells play twofold roles as radiating structures for the array antenna and as part of scattering structures for the low-RCS property.

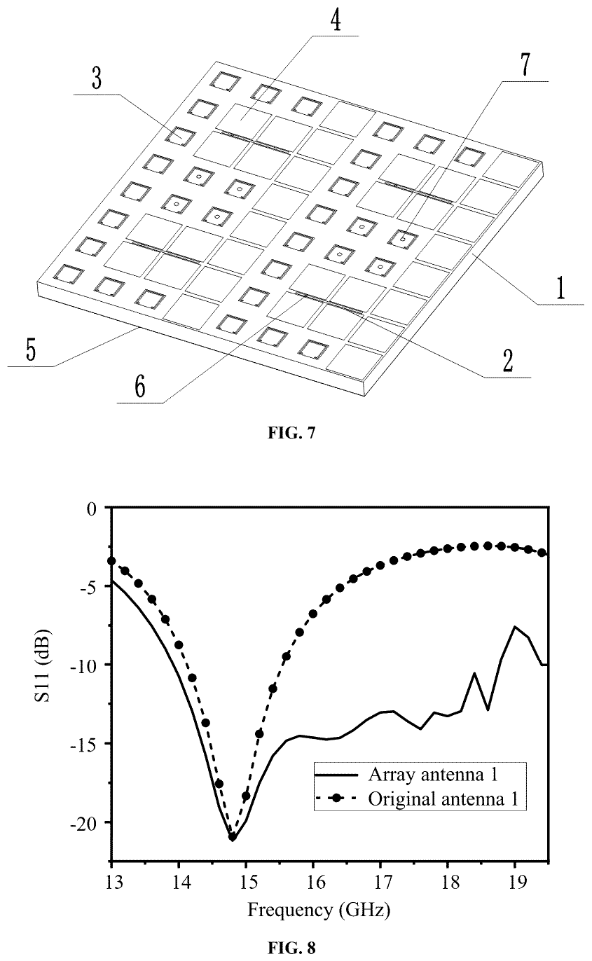

FIG. 7 illustrates an improved low-RCS metasurface-based 2*2 microstrip array antenna. In order to achieve better RCS reduction of the antenna array, eight metal posts 7 are respectively provided at centers of the first periodic metal cells 3. The metal post 7 passes through the dielectric substrate 1 and the metallic ground 5. The specific parameter is as follows: r1=0.2 mm. The dielectric substrate used by the antenna has a dielectric constant of 2.65 and a loss tangent of 0.003. The whole dielectric substrate of the antenna has a thickness of 1.6 mm.

The present disclosure will be further described below with reference to FIG. 1 to FIG. 20.

### Embodiment 1

According to the low-RCS metasurface-based microstrip array antenna, a feeding structure including the transmission line 2 and a probe is introduced. The interdigital arrangement of the two periodic metal cells and proper feeding techniques are exploited to excite parts of the metasurface cells to produce efficient radiations. Without affecting the radiation performance of the antenna, the metasurface realizes the in-band and out-of-band RCS reduction. For ease of understanding, Table 1 illustrates performance parameters of the microstrip array antenna.

TABLE 1

| | Integrated dual-antenna |
|---|---|
| | module provided by the |
| Parameter | present disclosure |
| Working frequency of the low-RCS | 13.92-18.78 GHz |
| metasurface-based 2*1 microstrip array antenna | |
| Working frequency of the low-RCS | 13.84-18.71 GHz |
| metasurface-based 2*2 microstrip array antenna | |
| Working frequency of the improved low-RCS | 13.99-19.08 GHz |
| metasurface-based 2*2 microstrip array antenna | |
| Whether the size is enlarged | No |
| Whether the gain is improved | Yes |
| Whether the in-band and out-of-band RCS of | Yes |
| the antenna is reduced | |

FIG. 8 illustrates a simulated S parameter curve of a low-RCS metasurface-based front-rear 2*1 array antenna. As can be seen from the figure, the original antenna has a central resonant frequency of 14.8 GHz, and a working band of 14.12-15.55 GHz. With the same central resonant frequency, the low-RCS metasurface-based antenna has a working band of 13.92-18.78 GHZ, and a wider impedance bandwidth.

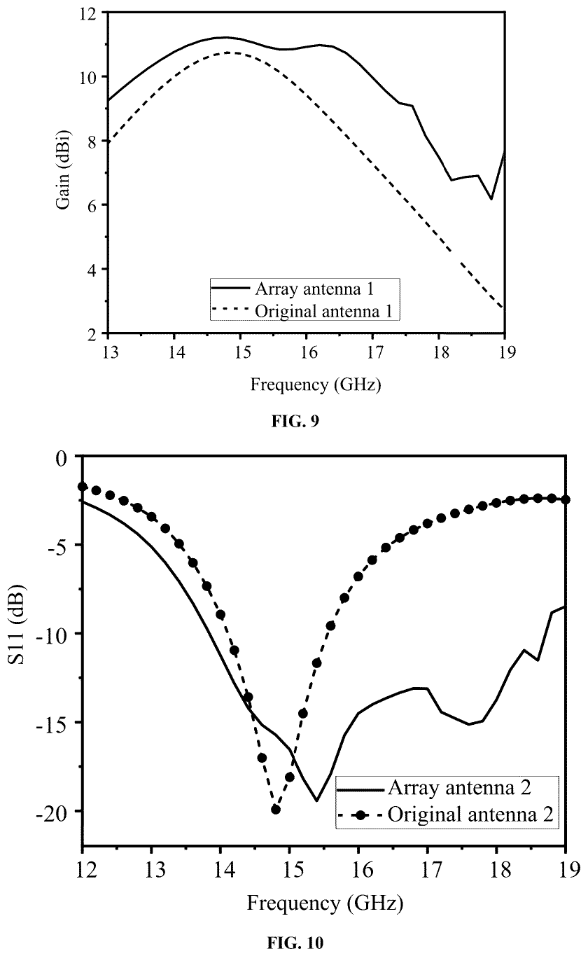

FIG. 9 illustrates a simulated gain curve of a low-RCS metasurface-based front-rear 2*1 array antenna. As can be seen from the figure, the original antenna has a gain of 10.73 dBi, while the low-RCS metasurface-based antenna has a gain of 11.21 dBi. The above results show that the radiation gain of the low-RCS metasurface-based array antenna is increased by 0.48 dB.

FIG. 10 illustrates a simulated S parameter curve of a low-RCS metasurface-based front-rear 2*2 array antenna. As can be seen from the figure, the original antenna has a central resonant frequency of 14.8 GHZ, and a working band of 14.11-15.56 GHZ. The low-RCS metasurface-based antenna has a central resonant frequency of 15.4 GHz that is deviated by 60 MHz to a high frequency, a working band of 13.84-18.71 GHz, and a wider impedance bandwidth.

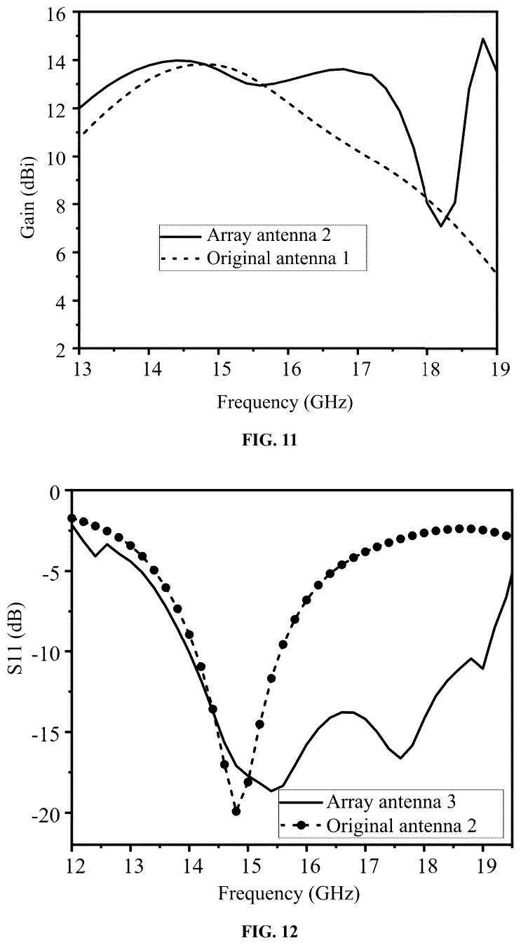

FIG. 11 illustrates a simulated gain curve of a low-RCS metasurface-based front-rear 2*2 array antenna. As can be seen from the figure, the original antenna has a gain of 13.83 dBi, while the low-RCS metasurface-based antenna has a gain of 13.83 dBi. The above results show that the radiation gain of the low-RCS metasurface-based array antenna is unchanged.

FIG. 12 illustrates a simulated S parameter curve of an improved low-RCS metasurface-based front-rear 2*2 array antenna. As can be seen from the figure, the original antenna has a central resonant frequency of 14.8 GHz, and a working band of 14.11-15.56 GHz. The low-RCS metasurface-based antenna has two resonant points at 15.4 GHz and 17.6 GHz, a working band of 13.99-19.08 GHz, and a wider impedance bandwidth.

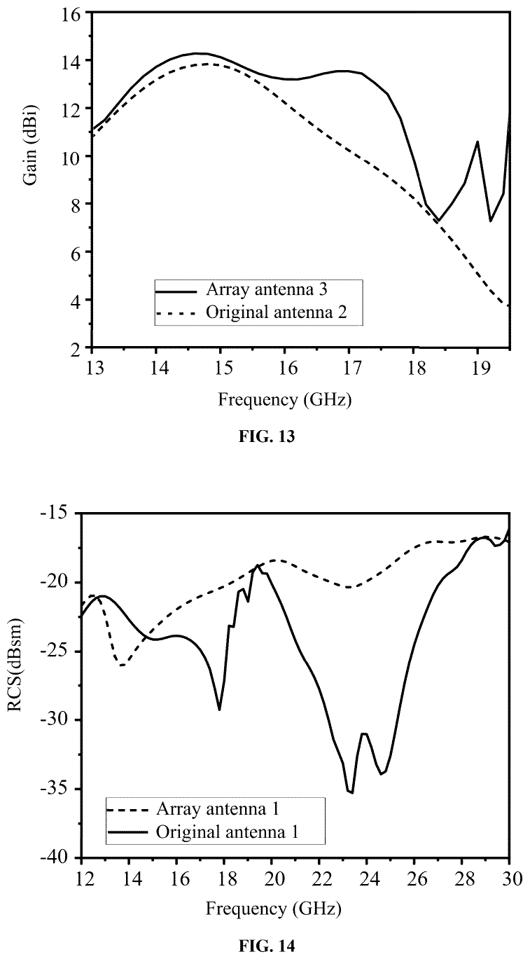

FIG. 13 illustrates a simulated gain curve of a low-RCS metasurface-based front-rear 2*2 array antenna. As can be seen from the figure, the original antenna has a gain of 13.83 dBi, while the low-RCS metasurface-based antenna has a gain of 14.25 dBi. The above results show that the radiation gain of the improved low-RCS metasurface-based array antenna is increased by 0.42 dB.

FIG. 14 simulates and compares a monostatic RCS of an original antenna under normal incidence of an x-polarized incident wave and a monostatic RCS of a low-RCS metasurface-based 2*1 array antenna under normal incidence of an x-polarized incident wave. As can be seen from the figure, the low-RCS metasurface-based 2*1 array antenna shows obvious RCS reduction in the frequency of 12-12.66 GHz and the frequency of 14.72-29.8 GHz.

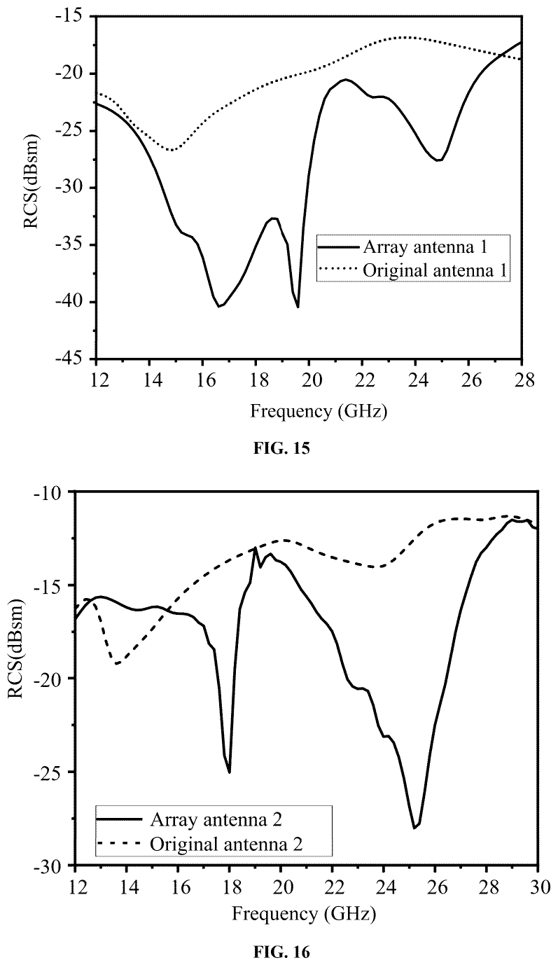

FIG. 15 simulates and compares a monostatic RCS of an original antenna under normal incidence of a y-polarized incident wave and a monostatic RCS of a low-RCS metasurface-based 2*1 array antenna under normal incidence of a y-polarized incident wave. As can be seen from the figure, the low-RCS metasurface-based 2*1 array antenna shows obvious RCS reduction in the frequency of 12-27.22 GHz.

FIG. 16 simulates and compares a monostatic RCS of an original antenna under normal incidence of an x-polarized incident wave and a monostatic RCS of a low-RCS metasurface-based 2*2 array antenna under normal incidence of an x-polarized incident wave. As can be seen from the figure, the low-RCS metasurface-based 2*2 array antenna shows obvious RCS reduction in the frequency of 12-12.6 GHz and the frequency of 15.6-30 GHz.

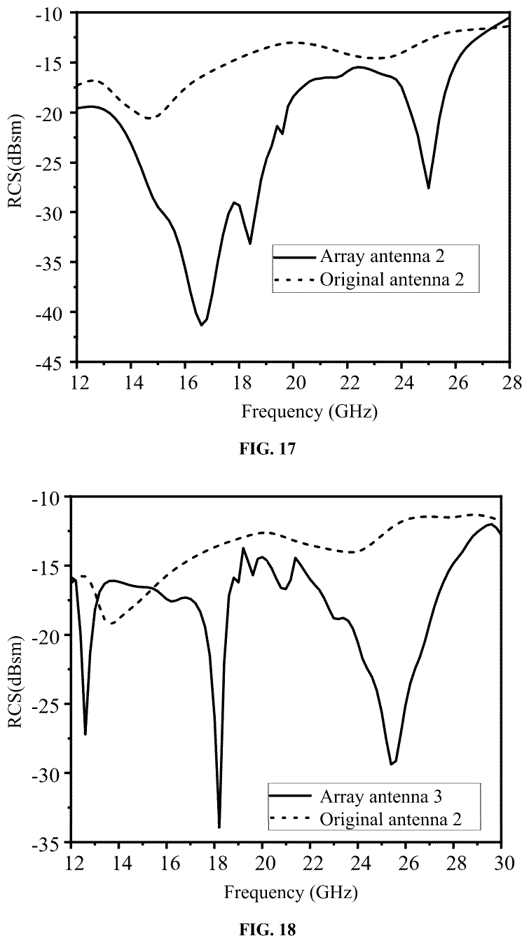

FIG. 17 simulates and compares a monostatic RCS of an original antenna under normal incidence of a y-polarized incident wave and a monostatic RCS of a low-RCS metasurface-based 2*2 array antenna under normal incidence of a y-polarized incident wave. As can be seen from the figure, the low-RCS metasurface-based 2*2 array antenna shows obvious RCS reduction in the frequency of 12-27.33 GHZ.

FIG. 18 simulates and compares a monostatic RCS of an original antenna under normal incidence of an x-polarized incident wave and a monostatic RCS of an improved low-RCS metasurface-based 2*2 array antenna under normal incidence of an x-polarized incident wave. As can be seen from the figure, the low-RCS metasurface-based 2*2 array antenna shows obvious RCS reduction in the frequency of 12.15-13.1 GHz and the frequency of 15.4-30 GHz.

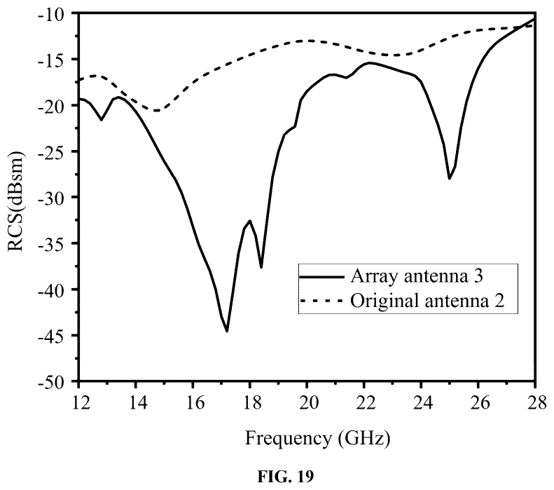

FIG. 19 simulates and compares a monostatic RCS of an original antenna under normal incidence of a y-polarized incident wave and a monostatic RCS of an improved low-RCS metasurface-based 2*2 array antenna under normal incidence of a y-polarized incident wave. As can be seen from the figure, the low-RCS metasurface-based 2*2 array antenna shows obvious RCS reduction in the frequency of 12-27.49 GHz.

In conclusion, based on the low-RCS metasurface, the present disclosure provide the low-RCS metasurface-based array antenna. The present disclosure can realize the in-band and out-of-band broadband low RCS and the good radiation performance, and can be well adapted for stealth application of the array antenna.

Specific examples are used in this description for illustration of the principles and embodiments of the present disclosure. The foregoing description is just meant to help understand the method of the present disclosure and its core idea. In addition, various modifications can be made by a person skilled in the art to the specific embodiments and the application scope in accordance with the idea of the present disclosure. In conclusion, the content of the present description shall not be construed as a limitation to the present disclosure.

What is claimed is:

1. A low-radar cross section (RCS) metasurface-based array antenna, comprising a dielectric substrate, and a transmission line, a plurality of first periodic metal cells and a plurality of second periodic metal cells printed on an upper surface of the dielectric substrate, and a metallic ground and a plurality of subminiature version A (SMA) feeding structures printed on a lower surface of the dielectric substrate, wherein the first periodic metal cells and the second periodic metal cells form a metasurface module on the upper surface of the dielectric substrate; an upper end of the SMA feeding structure extends to the upper surface of the dielectric substrate and is connected to the transmission line; a middle of the first periodic metal cell is provided with a metal post; and the metal post comprises a lower end located on the metallic ground, and an upper end extending to the upper surface of the dielectric substrate.

2. The low-RCS metasurface-based array antenna according to claim 1, wherein the metasurface module comprises sixteen first periodic metal cells and sixteen second periodic metal cells; the first periodic metal cells are arranged in two C shapes and form two side-by-side C-shaped structures; the second periodic metal cells are arranged in two T shapes and form two side-by-side T-shaped structures; one end of the T-shaped structure forms an extension portion; a groove is formed at one side of the C-shaped structure; the extension portion extends to the groove, so as to make the metasurface module form a 2*1 array antenna; there are two transmission lines; and the transmission lines are respectively located in middles of the extension portions.

3. The low-RCS metasurface-based array antenna according to claim 1, wherein the metasurface module comprises thirty-two first periodic metal cells and thirty-two second periodic metal cells; the first periodic metal cells are arranged in four C shapes and form four C-shaped structures; the four C-shaped structures have a same orientation, and are respectively located at corners of a rectangle; the second periodic metal cells are arranged in four T shapes and form four T-shaped structures; the four T-shaped structures have a same orientation, and are respectively located at corners of a rectangle; one end of the T-shaped structure forms an extension portion; a groove is formed at one side of the C-shaped structure; the extension portion extends to the groove, so as to make the metasurface module form a 2*2 array antenna; there are four transmission lines; and the transmission lines are respectively located in middles of the extension portions.

4. The low-RCS metasurface-based array antenna according to claim 1, wherein both the metallic ground and the dielectric substrate are rectangular; and outer edges of the metallic ground are respectively flush with outer edges of the dielectric substrate.
